(19) United States
(12) Patent Application Publication
(10) Pub. No.: US 2007/0130463 A1
(43) Pub. Date: Jun. 7, 2007

(54) Single one-time password token with single PIN for access to multiple providers

(76) Inventors: Eric Chun Wah Law, San Jose, CA (US); Lap Man Yam, Los Altos Hills, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/376,771

(22) Filed: Mar. 15, 2006

Related U.S. Application Data
(60) Provisional application No. 60/748,061, filed on Dec. 6, 2005.

(51) Int. Cl. H04L 9/00

(52) U.S. Cl. 713/168

(57) ABSTRACT

A system and a method are disclosed that includes a first party with a terminal and a one-time password token, one or more second parties, each with a host application system and a service provider authentication server, and a third party with a host application system and a master authentication server. The first party uses a single one-time password token with a single personal identification number (PIN) to access the one or more second parties. A third party issues the token to the first party and synchronizes token secrets and parameters with the one or more second parties. This offloads token management from the second parties and allows the second parties to directly authenticate the first party. The authentication of the first party by the second party does not involve the third party.

### CROSS REFERENCE TO RELATED APPLICATIONS

This application claims the benefit of U.S. Provisional Application No. 60/748,061, filed Dec. 6, 2005, which is incorporated by reference in its entirety.

This application is related to U.S. Patent Application No. ______, filed Mar. 15, 2006, titled “Asynchronous Encryption for Secured Electronic Communications”, which claims the benefit of U.S. Provisional Patent Application No. 60/748,111, filed Dec. 6, 2005, and titled “Asynchronous Encryption for Secured Electronic Communications”, the contents of each which is hereby incorporated by reference in its entirety.

### BACKGROUND

1. Field of the Art

The present invention generally relates to the field of secured electronic communication, and more specifically, to use of a single one-time password token and a single personal identification number (PIN) to access multiple service providers.

2. Description of the Related Art

The use of “user identification (ID) and password” as a method to access computing resources began in the 1950's during the early days of computing. At that time, access to computers was limited to only a small, select number of privileged users. At that time, the “user ID and password” system provided an adequate security measure for protection against unauthorized access. Today, with commercialization of the Internet and its rapid and exponential worldwide growth since 1995, the conventional user ID and password rapidly is becoming an inadequate mechanism of computing security.

Every day, the vulnerability of the static “user ID and password” becomes more noticeable as identity theft and unauthorized access to confidential and private information is besieged by user inability to protect such data as well as exposure to hackers and others with ill intentions. The conventional static “user ID and password” system is subject to password leakage during logon, password generation, storage and distribution. Current measures to enhance the security of the static “user ID and password” system such as hashing the password before sending it to the host system and asking the user to change password frequently are not effective and still vulnerable to interception and cracking.

For their part, when users are asked about security, their responses predictably resonate with concern. To protect themselves, many users may avoid online transactions when asked for a credit card number. In addition, some users may avoid web site member registration when asked to create a user ID and password and to provide personal information to complete that registration. In addition to security issues, users also express concerns about the volume of data that must be remembered. For example, the need for passwords with each user ID created requires the creation and remembrance of an excessive number of passwords, many of which are forgotten over time.

For those users that proceed with online transactions and registrations, the issue becomes maintaining security. Many users do not have an appreciation of, or patience with, good security practices. For example, many users do not change passwords on a frequent basis. In addition, it is not uncommon to find that many users use the same password for all applications and registrations. Such static passwords are inherently insecure. Neglecting security in this manner has encouraged fraudulent activity such as identity theft. However, even when users are highly cognizant of good security practices, the inherent vulnerability of the static “user ID and password” system has led to identity theft or misrepresentation without the user knowledge.

The concerns over security have exposed two fundamental problems. The first problem is the vulnerability of the static “user ID and password” system. The second problem is the need for different passwords for different systems. However, because users tend to dislike remembering multiple passwords, the end results continues to be compromising or ignoring recommended password policies that include (1) using “difficult to guess” password, (2) changing password frequently and (3) setting different passwords for different systems.

To address some of these shortcomings, some conventional systems offer an alternative to the static “user ID and password” system. For example, a two-factor authentication system requires the presentment of a second factor would greatly enhance the security level of the static “user ID and password” system. There are three types of authentication factors: (1) “what you know”—for example a password or personal identification number (PIN), (2) “what you have”—the presentment and verification of a personal belonging of the user such as a digital certificate on a smart card or a one-time password token and (3) “who you are”—biological characteristics verification (biometrics) of the user. Examples of biological characteristics include fingerprints, eye retinas and irises, voice patterns, facial patterns, hand geometry and handwriting.

The issues with the first authentication factor, a password or PIN have already been reviewed in detail. However, attempts to enhance authentication through the second authentication factor, for example a digital certificate (or signature), have not succeeded. Generally, digital certificate systems that are based on public key infrastructure (PKI) are considered to be secure if properly implemented. For example, creating and storing the private key inside a tamper-resistant smart card. In a conventional PKI system, the certificate authority issues digital certificates but they do not authenticate them. Service providers retrieve the public certificates of end users and validate them when the end users log-on or perform transactions.

Although well intentioned, the conventional PKI systems with client side user certificate implementations are uncommon and have lacked critical momentum. The primary concerns over its use have been poor usability and certificate logistics burden. For users, digital certificate systems require a “client side certificate.” This implementation is unacceptable because configuring the client side certificate is difficult and it also requires extensive logistics for certificate application. Further, proper use of the certificate is complicated and difficult for most users and its revocation and maintenance is equally laborious. Hence, an “ideal solution” of widespread acceptance of PKI and “cross-validation” and mutual acceptance of certificate authorities has never occurred. Thus, although the digital signing and encryption parts of the PKI technology are mature, its implementation requirements have prevented its popularity among the masses.

The third authentication factor, biometrics systems also have lacked success. Various types of biometrics systems vary in false acceptance rate and false rejection rate. Biometric systems having greater accuracy, for example iris and fingerprint systems, require more intrusive user interaction as well as secure biometric hardware. However, the costs of such system often prohibit large-scale implementations. Biometrics verification also relies on template comparison. This requires secure hardware on an end-to-end basis to limit exposure of the biometrics templates. In turn, this limits applications to closed systems or self-contained key locks.

Alternatives to biometric systems have been one-time password systems that substitute the static password with a dynamic password. Such systems address the first problem of vulnerability of the static “user ID and password” and have been gaining acceptance. However, one-time password systems do not resolve the problem of using different passwords for different systems because traditional one-time password systems are closed systems. Hence, the user is inconvenienced with subscriptions to more than one service provider. Each service provider requires a different token due to variations of individual service provider authentication servers. Further, some tokens require a PIN to operate and the user must remember the PIN for each different token, which adds to the user being inconvenienced.

From the above, there is need for a system and a method that allows a user to use a single token and a single PIN to access multiple service providers having a relationship with the user. There is also a need for a system and a method to centralize token management for issuance, revocation and re-issuance by an authority and also allow participating service providers to authenticate the user identity directly.

### SUMMARY

One embodiment of a disclosed system (and method) includes a system and a method to allow a user to use a single token and a single password or personal identification number (PIN) to access a multitude of service providers having a relationship with the user, that allows a centralized token management for issuance, revocation and re-issuance by an authority, and also allows participating service providers to directly authenticate the user identity as disclosed herein.

Advantages of the present invention includes a system and a method that allows a user to use a single token and a single PIN to access all service providers with whom the user has a relationship. The user beneficially need only remember a single password, or PIN, and thereafter is able to generate dynamic passwords that allow the user to continue an interchange with a service provider. Moreover, because the generated password is dynamic and thereafter discarded, security levels remain high.

Another advantage of the present invention includes centralized token management of issuance, revocation and re-issuance by a secured authentication and key system. Moreover, the user and the service provider do not require the secured authentication and key system to participate in exchanges between the user and service provider. Rather, the system is configured to allow the participating service provider to directly authenticate the user identity.

The features and advantages described in the specification provide a beneficial use to those making use of a system and a method as described in embodiments herein. For example, a user is provided mechanisms, e.g., by receiving and/or transmitting control signals, to control access to particular information as described herein. Further, these benefits accrue regardless of whether all or a portion of components, e.g., server systems, to support their functionality are located locally or remotely relative to the user.

In addition, the features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The disclosed embodiments have other advantages and features which will be more readily apparent from the following detailed description and the appended claims, when taken in conjunction with the accompanying drawings, in which:

Figure (FIG.) 1 illustrates one embodiment of an environment overview in accordance with the present invention.

FIG. 2a illustrates one embodiment of a one-time password token and single personal identification number (PIN) system in accordance with the present invention.

FIG. 2b illustrates one embodiment of a token in accordance with the present invention.

FIG. 3 illustrates one embodiment of a process for token issuance in accordance with the present invention.

FIG. 4 illustrates one embodiment of a process for token revocation in accordance with the present invention.

FIG. 5 illustrates one embodiment of a process for changing a PIN in accordance with the present invention.

FIG. 6 illustrates one embodiment of a process for direct user authentication by a service provider in accordance with the present invention.

FIG. 7 illustrates one embodiment of a process for synchronization of token datasets in accordance with the present invention.

### DETAILED DESCRIPTION

The Figures (FIGS.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles described herein.

Environment Overview

Figure (FIG.) 1 illustrates one embodiment of an environment overview in accordance with the present invention. By way of example, an environment may include a user 110, one or more service providers 120, and a secured authentication and key system 130. The systems may be connected by one or more networks (e.g., a data network and/or a mobile telephone network). Initially, for ease of understanding overall aspects, the environment will be described in more general terms below.

Generally, the disclosed embodiments describe a system and a method for a first party (e.g., a user 110) to use a single token with a single (or one) personal identification number (PIN) to access one or more second parties (e.g., one or more service providers 120). It is noted that the one or more second parties can be any party with whom the first party transacts. For example, it may be online commerce (e.g., a purchase at amazon.com), in-person commerce (e.g., electronic check out and payments at a grocery store (or other “brick and mortar” commerce location)), or electronic mail (e-mail or email) communication (e.g., verify recipient/sender in an email exchange).

In one embodiment, the system and the method enable a third party (e.g., a secured authentication and key system 130, including user profile management) to issue token dataset to the first party and synchronize the token dataset (that contains token secrets and parameters) with the second party. Thus, token management is offloaded from the second party while allowing the second party to directly authenticate the first party. The authentication of the first party by the second party does not need to involve the third party.

In one embodiment, the first party has a terminal (e.g., a personal computer, a smartphone, a personal digital assistant, or other device structured configured to operate as described herein) and a token. In one embodiment, the token includes a token application, one or more cryptography modules (e.g., algorithms), and one or more token datasets. The second party has an authentication server that contains the same cryptographic modules, token secrets and parameters with respect to the token 214 of the first party.

To authenticate the identity of the first party by the second party, the first party uses the terminal to send an authentication request to a host application server of the second party. The host application of the second party requests the first party to provide (supply) a one-time password. The first party uses its token with shared secrets and parameters known to the authentication server of the second party to generate (e.g., compute) the one-time password. The one-time password is submitted to the host application of the second party. The host application of the second party requests the authentication server of the second party to verify the one-time password provided by the first party. Upon successful verification of the one-time password, the authentication server advises the host application to grant access to the first party. In doing so, the second party does not need to manage the token life cycle including issuance, revocation and re-issuance.

A third party serves as the central authority for token management. The third party personalizes a token of the first party when requested by the first party. Personalization includes issuance, revocation, or re-issuance of a token dataset or a change of PIN (that is part of the token dataset). The third party would logically partition the token dataset to hold multiple compartments of token secrets and parameters where each compartment is used to hold an independent set of token secrets and parameters for each second party. The second party has a token synchronization server that would synchronize the token secrets and parameters of all users with the token synchronization server of the third party.

System Overview

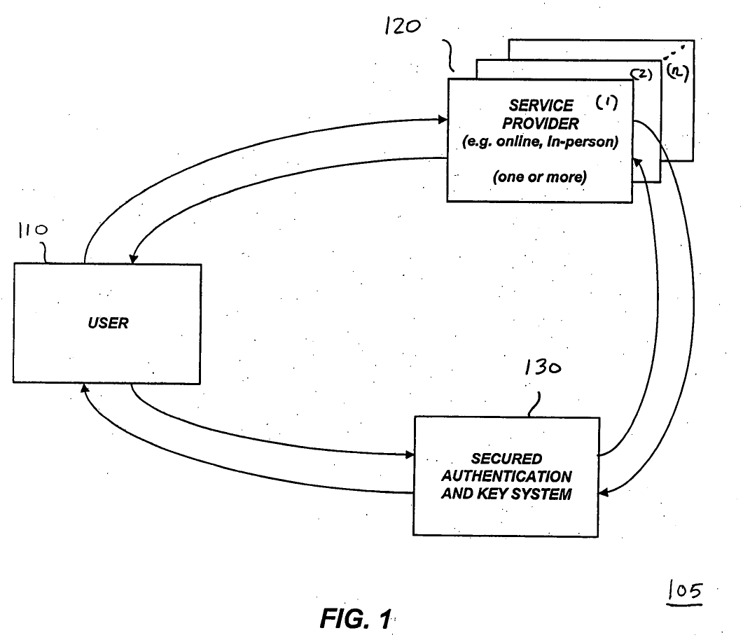

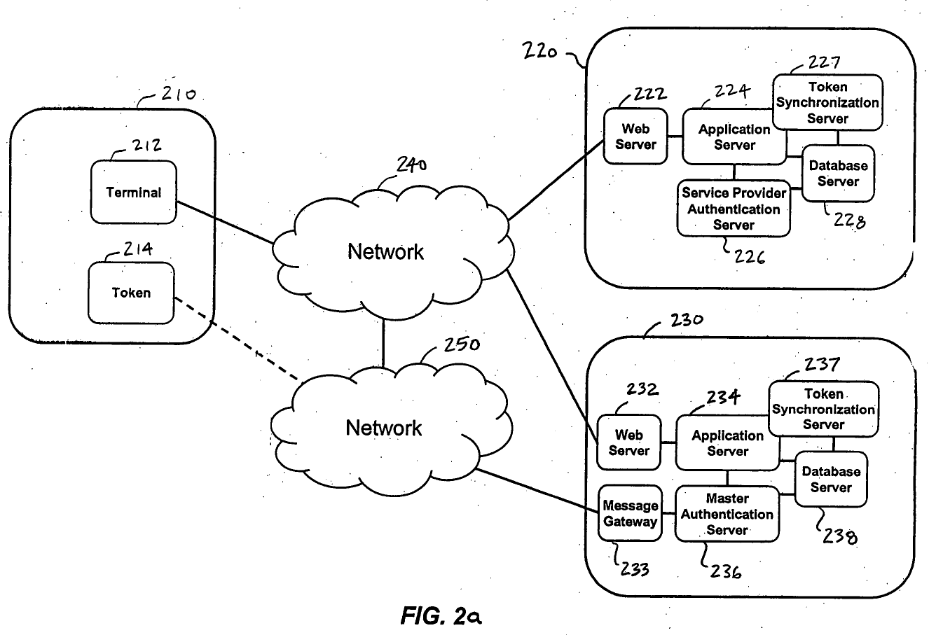

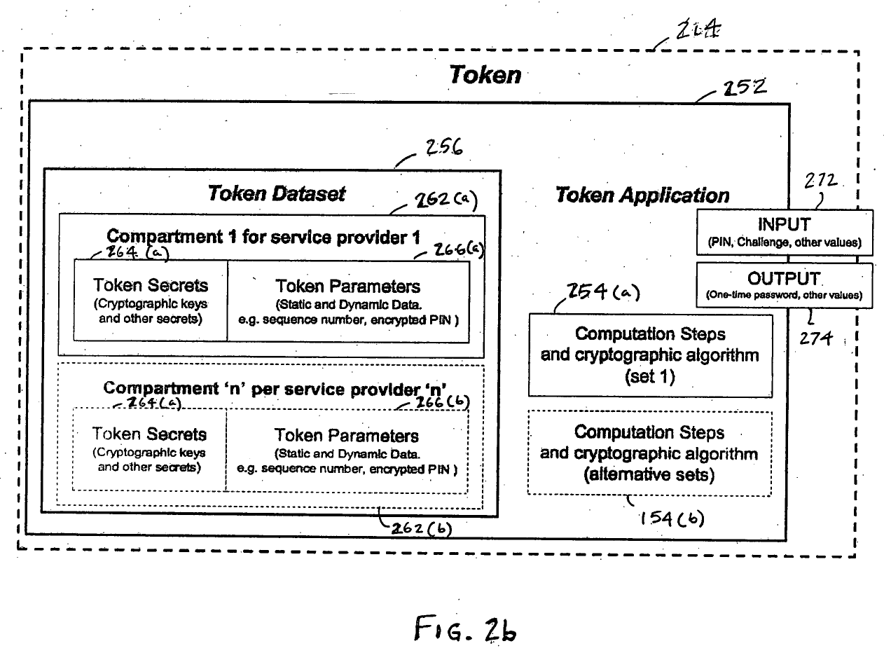

Referring now to FIG. 2a, it illustrates one embodiment of a one-time password token and single PIN system in accordance with the present invention. In particular, the figure will be used to describe connectivity between (1) a first party 210 with a terminal and a token, (2) a second party 220 with a web server, an application server, a service provider authentication server, a database server and a token synchronization server and (3) a third party 230 with a web server, an application server, a master authentication server, a database server, a token synchronization server and a message gateway. The first party 210 and the second party 220, as well as the second party 220 and the third party 230, are communicatively coupled through a first network 240. In addition, the first party 210 and the third party 230 are communicatively coupled through a second network 250 that is optional. The first network 240 also communicatively couples the optional second network 250.

The first party 210 comprises a terminal 212 and a token 214. The terminal 212 is a computing device equipped and configured to communicate with the second party 220 and the third party 230 through the first network 240. Examples of the terminal 212 include a personal computer, a workstation, a laptop computer, or a personal digital assistant (PDA) with a wired or wireless network interface card or a smartphone or a mobile phone with a cellular access. In general, it is noted that the first-party system 210 is structured to include a processor, memory, storage, network interfaces, and applicable operating system and other functional software (e.g., network drivers, communication protocols, etc.).

The token 214 is a security mechanism that provides a one-time password. The token 214 may be a standalone separate physical device dedicated to running a token application 252 (further describe with FIG. 2b) or may be an application or applet running on the terminal 212 or a separate standalone physical device (e.g., a sub-notebook or laptop computer, a mobile phone, smartphone, or a personal digital assistant).

FIG. 2b illustrates one embodiment of the token 214 in accordance with the present invention. The token 214 includes a token application 252. The token application 252 includes one or more programmed cryptographic algorithms (or modules) 254a-n (n being any integer) (generally referenced as 254) and one or more token datasets 262a-n (n being any integer (generally referenced as 262). Embodiments with multiple cryptographic algorithms (or module) 254 and token datasets 262 may be available for maximum flexibility of interoperation with multiple second parties 220, each of which may use a different cryptographic algorithm or with which a user may desire to use a different cryptographic algorithm.

Each token dataset 256 includes one or more token secrets 264 and token parameters 266. The token secrets 264 include, for example, cryptographic keys, random numbers, control vectors and other secrets for computation and cryptographic operations by the token 214, the service provider authentication server 226, and/or the master authentication server 236. The token parameters 266 refer to the control parameters, for example, encrypted PIN, a monotonically increasing or decreasing sequence number, optional transaction challenge code, transaction digests and usage statistics. Some of the token parameters 266 are dynamic and are updated upon authentication operations.

The token 214 also may include an input interface 272 and an output interface 274. The input interface 272 receives, for example, the PIN, a challenge, and other values such as an input of a monetary value for a transaction. The output interface 274 transmits, for example, a one-time password and other values such as the input monetary value. It is noted that in one embodiment, the token application 252 may be pre-installed on the token 214. In other embodiments, the token application 252 may be downloaded from a third party.

In one embodiment, the terminal 212 and the token 214 function together to form a user authentication mechanism. For example, it may include a two-factor authentication system, along with a user identification (ID). The user ID can be any unique identifier, for example, an electronic mail (e-mail or email) address, a telephone number, or a personal identity code or number (e.g., member number, employee number).

In cases where a user has more than one unique identifier of the same type, for example, email, and the user prefers to use a single token to identify all of the unique identifiers of the same type, e.g., email addresses, the system is configured to allow the user to do so by having the token remain as the user's only digital identity, representing all of user's unique identifiers of the same type, e.g., email addresses. If the user prefers to create multiple digital identities for oneself, the system is configured to provide such flexibility for the user to create multiple tokens for multiple unique identifiers of the same type, e.g., email addresses or multiple groups of email addresses.

The “two factors” refer to “what you know” and “what you have”. The “what you know” factor is a password and a PIN. The PIN can be one or more numbers (e.g., 0-9), alpha characters (e.g., A-Z), special characters (e.g., @, #, %, etc.), or a combination of any of these. The “what you have” factor is a personal belonging of a user. The personal belonging is typically a tangible device that can function as the token 214. Examples include a personal computer, a workstation, a mobile phone or smartphone, a Universal Serial Bus (USB) memory stick with programmed application, a personal digital assistant, or a standalone separate hardware token device. The token 214 provides a generated one-time password in response to being triggered by the application of the first factor, i.e., the PIN.

The second party 220 includes a web server 222, an application server 224, a service provider authentication server 226, a database server 228 and a token synchronization server 227. The web server 222 communicatively couples the first network 240 and the application server 224. The application server 224 communicatively couples the service provider authentication server 226 and the database server 228. The database server 228 communicatively couples the service provider authentication server 226 and the token synchronization server 227.

The web server 222 is a front end into the second-party system 220 and functions as a communication gateway into the second-party system 220. It is noted that the web server 222 is not limited to an Internet web server, but rather can be any communication gateway that appropriately interfaces the first network 240, e.g., a corporation virtual private network front end, a cell phone system communication front end, or a point of sale communication front end. For ease of discussion, this front end will be referenced as a web server 222, although the principles disclosed are applicable to a broader array of communication gateways.

The application server 224 is configured to serve requests (logons, enquiries and transactions) from the terminal 212 of the first party 210. The service provider authentication server 226 is configured to serve authentication requests from the application server 224. The token synchronization server 227 is configured to interface with the token synchronization server 237 of the third party 230 and to collect updated token datasets for the corresponding first parties 210 from the third party 230. The database server 228 is configured to store applications, data and other information from the application server 224, the authentication server 226, and the token synchronization server 227.

The second party system 220 can be configured on one or more conventional computing systems having a processor, memory, storage, network interfaces, peripherals, and applicable operating system and other functional software (e.g., network drivers, communication protocols, etc.). In addition, it is noted that the servers 222, 224, 226, 227 and 228 are logically configured to function together and can be configured to reside on one physical system or across multiple physical systems.

The third-party system 230 provides a secured authentication and key system that includes user profile management. The third-party system 230 includes a web server 232, message gateway 233, an application server 234, a master authentication server 236, a database server 238, and a token synchronization server 237. The web server 232 communicatively couples the first network 240 and the application server 234. The message gateway 233 communicatively couples the optional second network 250 (or if it is not present, it communicatively couples the first network 240) and the master authentication server 236. The application server 234 communicatively couples the master authentication server 236 and the database server 238. The database server 238 communicatively couples the master authentication server 236 and the token synchronization server 237.

The web server 232 is a front end into the third-party system 230 and functions as a communication gateway into the third-party system 230. It is noted that the web server 232 is not limited to an Internet web server, but rather can be any communication gateway that appropriately interfaces the first network 240, e.g., a corporation virtual private network front end, a cell phone system communication front end, or a point of sale communication front end. For ease of discussion, this front end will be referenced as a web server 232, although the principles disclosed are applicable to a broader array of communication gateways. In addition, the message gateway 233 is also a front-end into the third-party system 230 and functions as a second communication gateway into the third-party system 230. The message gateway 233 can be any messaging communication gateway that interfaces with the second network 250, e.g., an instant messenger or short message service (SMS) system.

The application server 234 is configured to serve requests (logons, enquiries and token personalization such as token issuance, revocation and re-issuance) from the terminal 212 of the first party 210. The master authentication server 236 is configured to serve authentication requests from the application server 234. The token synchronization server 237 is configured to interface with the token synchronization server 227 of the second party 220 and to deliver updated token datasets for the corresponding first parties 210 to the second party 220. The database server 238 is configured to store applications, data and other information from the application server 234, the authentication server 236, and the token synchronization server 237.

The third-party system 230 can be configured on one or more conventional computing systems having a processor, memory, storage, network interfaces, peripherals, and applicable operating system and other functional software (e.g., network drivers, communication protocols, etc.). In addition, it is noted that the servers 232, 233, 234, 236, 237 and 238 are logically configured to function together and can be configured to reside on one physical system or across multiple physical systems.

In one embodiment, operation of the one-time password token and single PIN system can be described by way of an example in which a general network arrangement has the second party 220 to authenticate the first party 210. The first party 210 requests the third party 230 to personalize a one-time password token, which includes the token application 252 and the token dataset 262 that contains token secrets 264 and parameters 266. The second party 220 synchronizes token secrets and parameters with the third party 230. It is noted that although the description is provided relative to one second party 220 for this example, it should be understood that there can be more than one second party and each would authenticate the first party 210 and synchronize with the third party 230 as noted herein.

With respect to an example of operation, it is initially noted that the token 214 and the service provider authentication server 226 share the same set of a token cryptographic algorithm, token secrets and parameters, which were collected from the token synchronization server 237 of the third party 230. When an authentication function must be performed between the first party 210 and the second party 220, the first party 210 uses its terminal 212 to connect to the web server 222 of the second party 220 to request authentication.

The web server 222 passes the authentication request that contains unique user identification such as the email address of the first party 210 to the application server 224. Based on the user identification, the application server 224 searches for a corresponding token identifier of the first party 210 in the database server 226. The token identifier is an identification number or pointer to the actual token secrets and parameters for the corresponding first party 210. Once located, the application server 224, through the web server 222, requests the first party 210 to submit a one-time password.

The first party 210 uses its token 214 to generate (or compute) the one-time password. The one-time password is submitted through the terminal 212 and via the first network 240 to the web server 222 and then to the application server 224. The application server 224 forwards the token identifier and the one-time password to the service provider authentication server 226. The service provider authentication server 226 retrieves the encrypted token secrets and current token parameters corresponding to the token identifier from the database server 228. The service provider authentication server 226 decrypts the token secrets and token parameters and verifies the received one-time password. Upon successful verification, the service provider authentication server 226 advises the application server 224 to grant access to the first party 210.

In a token life cycle, the first party 210 connects to a user profile management system (not shown) of the third party 230 using a similar authentication procedure. That is, the first party 210 uses the terminal 212 to connect to the web server 232 of the third party 230 and requests authentication. The web server 232 passes the authentication request to the application server 234. The application server 234 searches for a corresponding token identifier of the first party 210 in the database server 238.

Once located in the database, the application server 234 requests, through the web server 232, the first party 210 to submit a one-time password. The first party uses its token 214 to generate (or compute) a one-time password. This one-time password is submitted through the terminal 212 to the web server 232 via the first network 240 and then to the application server 234. The application server 234 forwards the token identifier and the one-time password to the master authentication server 236.

Using the received token identifier and one-time password, the master authentication server 236 retrieves the corresponding encrypted token secrets and current token parameters from the database server 238. The master authentication server 236 decrypts the token secrets and token parameters and verifies the received one-time password. Upon successful verification, the master authentication server 236 responds to the application server 234 by advising it that authorization has cleared so that access may be granted to the first party 210.

In some instances the first party 210 may seek to change a PIN. To change the PIN, the first party 210 sends the PIN change request to the third party 230 by hashing the PIN first. In such instances, the master authentication server 236 encrypts the hashed PIN uniquely for each second party 220.

Likewise, in some instances the first party may need to apply for a new token dataset for the token 214 and/or revoke the token dataset of an old token 214. To apply for a new token dataset or to revoke the dataset of an old token and apply for a new token dataset, the first party 210 transmits (or sends) a token application request to the third party 230. The master authentication server 236 voids the old token dataset of token secrets and parameters (if any) associated with the old token according to the token identifier. The master authentication server 236 also issues a new token dataset of token secrets and token parameters (if any). If the first party 210 has subscribed to more than one second party 220, the token dataset corresponding to the token 214 would contain more than one compartment of token secrets and parameters. In addition, the master authentication server 236 uniquely encrypts for each second party 220 the corresponding compartment of new token secrets and token parameters associated with the new token.

In embodiments where the new token 214 is a mobile phone, the master authentication server 236 can be configured to use the message gateway 233 to send an auto-configuration message to the token 214 via a mobile phone network, e.g., the second network 250. In embodiments where the new token 214 is a personal computer, a PDA or other portable device connected to an online network, e.g., the first network 240, the master authentication server 236 will send a notification message to the terminal 212. The notification message informs the first party 210 to download an auto-configuration message from the master authentication server 236 to the token 214 via the application server 234 and web server 232. After the token is updated, the token synchronization server 237 will advise the synchronization server 227 of each second party 220 that the first party 210 has relationship or membership with. The token synchronization server 227 may decide to synchronize token datasets with the third party 230 immediately or periodically. The token synchronization server 227 of the second party 220 then securely connects to the token synchronization server 237 of the third party 230 to retrieve the latest version of token secrets and parameters for the first party 210.

Thus, the disclosed systems and methods include a number of advantages and benefits over existing one-time password technology. For example, there is an advantage of eliminating a need for different passwords for different systems through enabling a first party to use a single one-time password token and a single PIN to access one or more different second parties. In addition, the token dataset can be revoked, replaced, and/or updated for a first party by a third party and the third party arranges for synchronizing the updated token datasets with the relevant second parties. The first party is shielded from a potentially cumbersome process of notifying all second parties and second parties are able to retrieve and synchronize the necessary token dataset information from the third party to directly authenticate a first party. This increases overall transaction and/or message efficiency and speed.

Example Process Using Single One-Time Password and Single Pin

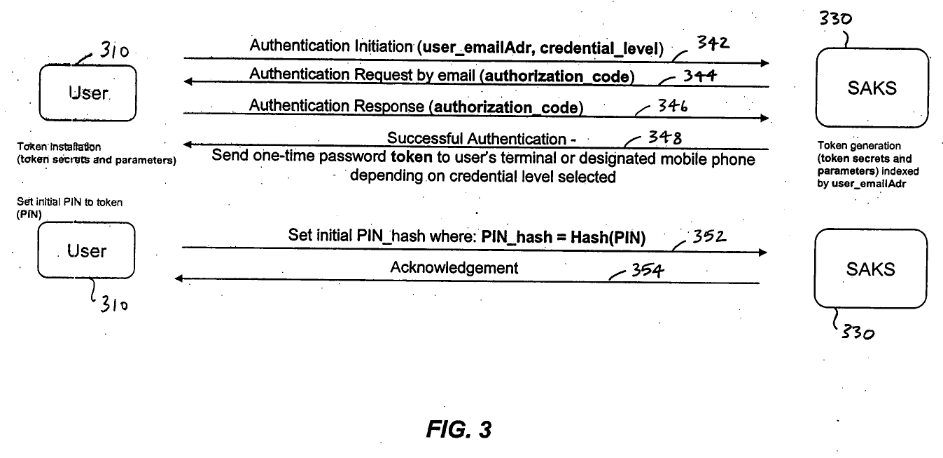

The principles described herein can be further described through particular examples for various processes for obtaining, maintaining, and verifying a one-time password and single PIN in accordance with the present invention. In the examples that follow in FIGS. 3 through 7, there is a user, a service provider and a secured authentication and key system. The user is functionally similar to the first party 210, the service provider is functionally similar to the second party 220, and the secured authentication and key system is functionally similar to the third party 230.

It is noted that there may be one or more users and one or more service providers, but for ease of understanding only one is described for each. In addition, the processes described with respect to these parties are performed on the respective terminal, computing system, and/or token as previously described. Communication between the user, the service provider and the secured authentication and key system is through one or more networks functionally similar to the first network 240 and/or the second network 250.

Turning first to FIG. 3, it illustrates one embodiment of a process for token issuance in accordance with the present invention. It is noted that in the described example embodiment, token issuance includes a process of issuing a token dataset that contains token secrets and parameters for installation into a token application that has been loaded into token.

In FIG. 3, a user 310 initiates 342 authentication by transmitting an email address and a desired token credential level to a secured authentication and key system 330. A token credential level refers to the trustworthiness of the token application itself. For example, a token application running in a physical device separated from a user terminal (e.g., personal computer) is generally considered as more secure and trustworthy than a token application running in the same user terminal. In such examples, a mobile phone to serve as a token may have a higher token credential level than the user terminal to serve as a token.

To verify the authenticity of the user, the secured authentication and key system 330 replies 344 back to the user 310 with an authentication request containing an authorization code. The user 310 transmits 346 the authorization code back to the secured authentication and key system 330. Echoing the authorization code in this manner confirms that the authorization code has been successfully received by the actual (or genuine) user 310. This process helps verify the authenticity of the submitted user identification, which in this example is the user email address.

Next, the secured authentication and key system 330 generates a new token dataset that includes one or more compartments of token secrets and parameters, which are indexed in a database, e.g., the database 238, by user email address. The number of partitioned compartments of token secrets and parameters depends on the total number of service providers that the user 310 has subscribed. Optionally a token application may be bundled with the token dataset as a single delivery item, for example, when the token device 214 does not initially have a token application and must receive and install one for operation in accordance with the principles disclosed herein.

As previously noted, token secrets refer to cryptographic keys, random numbers, control vectors and other secrets for computation and cryptographic operations by the token itself and by the authentication server. Likewise, as previously noted, token parameters refer to the control parameters such as encrypted PIN, a monotonically increasing or decreasing sequence number, optional transaction challenge code, transaction digests and usage statistics. Note that some of the token parameters may be dynamic, and therefore, may be updated upon authentication operations.

Depending on the selected credential level, the generated one-time password token dataset is sent (or transmitted) 348 to a terminal of the user, e.g., terminal 212 on which the token application runs or from which it can be installed on the token 214, through a data network, e.g., the first network 240. Alternatively, it may be sent (or transmitted) 348 to a separate physical device such as a mobile telephone or smartphone on which the token application resides (or runs), through a mobile telephone network, e.g., the second data network 250.

Once the one-time password dataset is received, the user 310 installs the one-time password token dataset (and optionally the token application if not already installed) on its token 214, e.g., on the terminal 212 if it also serves as a token or on separate device that serves as a token. In embodiments in which the token 214 resides in the user terminal 212, the token dataset (and optionally bundled token application) is downloaded to the terminal 212 and installed automatically. In embodiments in which the token 214 is a mobile phone, the token dataset (and optionally bundled token application) is downloaded to the mobile phone using SMS push technology, e.g., the user 310 receives a SMS message to the user designated mobile phone (which will be the token 214) to initiate an online download sequence of the token dataset upon user confirmation (e.g. clicking a “YES”, “follow link” or similar download button).

After installation, the user 310 sets an initial PIN for the token by selecting a “SET PIN” function from the token application. The new PIN is then hashed by the token application and the hashed PIN is transmitted 352 to the secured authentication and key system 330. The secured authentication and key system 330 stores the hashed PIN in the database with the indexed user email address and optionally transmits 354 an acknowledgment back to the user 310 that the hashed PIN was received and stored. In this embodiment, the secured authentication and key system 330 does not have knowledge about the user PIN in clear form since hashing is non-reversible.

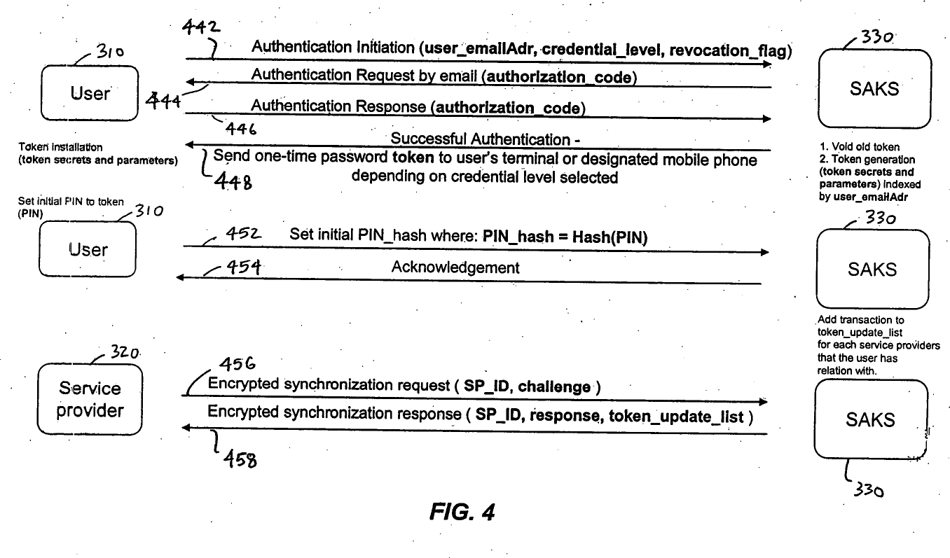

In some instances, a user 310 may need to have a token dataset revoked. FIG. 4 illustrates one embodiment of a process for token revocation in accordance with the present invention. It is noted that in one embodiment, token revocation may also include a process of revoking a token dataset of an existing token application that has been loaded into token. The user 310 initiates authentication by transmitting 442 to the secured authentication and key system 330 authentication information that includes the user email address, token credential level, and a revocation instruction. In one embodiment, the revocation instruction may be a “checkbox” operation or dialog box on the user terminal that asks whether to revoke, and if so, a revocation flag is transmitted to the secured authentication and key system 330.

The secured authentication and key system 330 replies 444 back to the user 310 with an authorization code in the authentication request. The user 310 transmits 446 the authorization code back to the secured authentication and key system 330. Once the authorization code is received and the secured authentication and key system 330 is able to confirm authorization, the secured authentication and key system 330 voids the old token and generates a new token dataset, including new token secrets and parameters. The new token dataset is indexed and stored in the database of the secured authentication and key system 330 with the user email address. The new token dataset (and optionally a bundled token application) is transmitted 448 to the user 310, e.g., the terminal 212 or other token device, e.g., mobile phone or smartphone, over the appropriate network.

The user 310 installs the received token dataset, including token secrets and parameters, on the token 214. After installation, the user 310 sets an initial PIN for the token application. The new PIN is then hashed and the hashed PIN is transmitted 452 to the secured authentication and key system 330. The secured authentication and key system 330 stores the hashed PIN in the database with the indexed user email address and optionally transmits 454 an acknowledgment back to the user 310 that the hashed PIN was received and stored.

In addition, the secured authentication and key system 330 adds the token update information to an updated token transaction list that will be used to update each service provider 320 with whom that user 310 has a relationship. When the service provider 320 requests 456 synchronization with the secured authentication and key system 330, it sends an encrypted version of its service provider identification and a cryptographic challenge code to the secured authentication and key system 330. In response, the secured authentication and key system 330 transmits 458 back an encrypted version of the updated token transaction list together with a cryptographic “response to the challenge code” to the service provider 320. The service provider 320 updates its database with this synchronized information.

The token synchronization servers of service provider 320 and the secured authentication and key system 330 have pre-defined shared secrets (cryptographic keys, vectors and algorithms) and parameters (e.g., transaction sequence number for prevention of a ‘re-play’ attack) installed during initial system setup. The challenge-response protocol is a commonly used approach for mutual authentication and is used here as an example. Further, the token synchronization process of the service provider 320 can occur immediately when triggered by the secured authentication and key system 330 or can take place periodically and this preference setting is configurable.

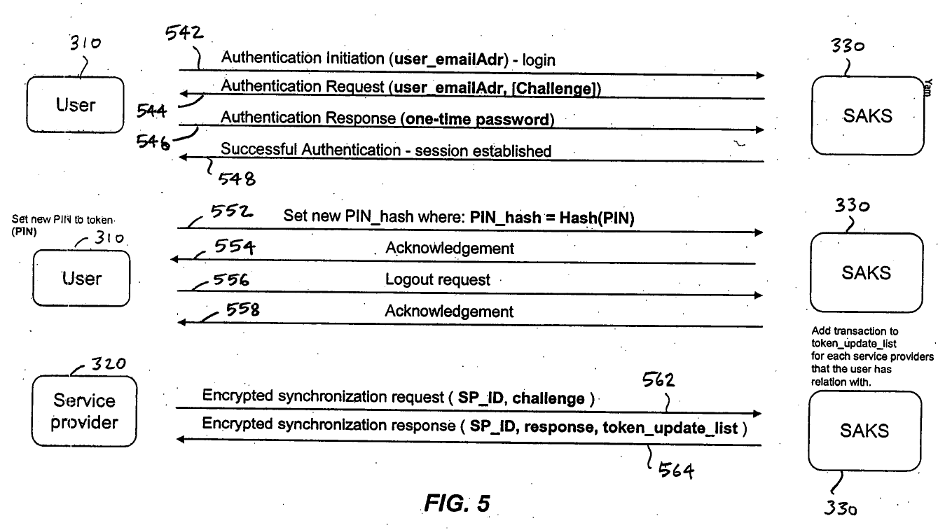

In some instances, a user 310 may wish to change a PIN for the token. FIG. 5 illustrates one embodiment of a process for changing a PIN in accordance with the present invention. A user initiates the process by transmitting 542 to the secured authentication and key system 330 login information, for example, the user email address along with its one-time password 546.

There are two authentication modes, namely simple mode and challenge-response mode. For the simple mode, the secured authentication and key system 330 verifies the one-time password 546 given by the user 310 where the one-time password was generated through the token of the user 310. For the challenge-response mode, the authentication initiation 542 does not include a one-time password 546 from the user 310. The secured authentication and key system 330 transmits 544 back to user 310 an authentication request that includes a “challenge” code, e.g., a random number from the secured authentication and key system 330 used for enhanced security. In response to the request and the challenge code, the user 310 uses its token to generate a one-time password. The user 310 transmits 546 a response to the secured authentication and key system 330 that includes this generated one-time password. The secured authentication and key system 330 verifies the one-time password and, if authorization is successful, it establishes a session and notifies 548 (or transmits information to the user regarding the established session) the user 310.

With the established session, the user then sets a new PIN for the token application. The new PIN is hashed and transmitted 552 to the secured authentication and key system 330. The secured authentication and key system 330 receives the hashed PIN, encrypts and stores it in its database, e.g., database 238, with the indexed user email address and transmits 554 an acknowledgement back to the user 310. The user then sends (or transmits) 556 a logout request to the secured authentication and key system 330. The secured authentication and key system 330 receives the request, ends the session, and transmits 558 an acknowledgement back to the user 310 that the session has been terminated.

In addition, the secured authentication and key system 330 adds the token update information to an updated token transaction list that will be used to update each service provider 320 with whom that user 310 has a relationship. When the service provider 320 requests 562 synchronization with the secured authentication and key system 330, it sends an encrypted version of its service provider identification and a cryptographic challenge code to the secured authentication and key system 330.

In response, the secured authentication and key system 330 transmits 564 back an encrypted version of the updated token transaction list together with a cryptographic response code to the service provider 320. The service provider 320 updates its database, e.g., database 228, with this synchronized information. The successful verification of the cryptographic challenge and response codes by service provider 320 and the secured authentication and key system 330 means the two connecting parties have mutually authenticated themselves and a secure communication channel is then established for token synchronization.

With the token dataset appropriately established for the user 310, logged with the secured authentication and key system 330, and synchronized with a service provider 320, the user 310 and the service provider 320 are ready to transact with each other. The initial transaction between the two parties is user authentication. An advantage of the present invention is that it allows the service provider 320 to directly authenticate the user 310 without the need to have the secured authentication and key system 330 intervene during the transaction.

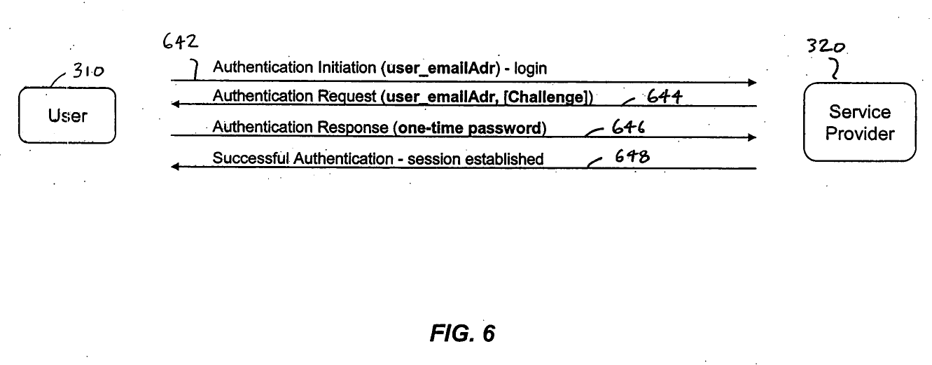

FIG. 6 illustrates one embodiment of a process for direct user authentication by a service provider in accordance with the present invention. The process begins with the user 310 initiating authentication by initiating login into the service provider 320, for example, by transmitting 642 an email address and 646 a one-time password to the service provider 320 where the one-time password was generated from the user token, e.g. token 214. Optionally if the challenge-response logon method is used, the user 310 does not need to send 646 one-time password in the authentication initiation step. Instead, the service provider 320 looks up the user email address in its data base and if the user is located therein, it replies 644 back to the user 310 a challenge code. The user 310 receives the challenge code and generates (or calculates) a one-time password using the user token, e.g., token 214.

The generated one-time password is transmitted 646 to the service provider 320. The service provider 320 verifies the generated one-time password against what should be the appropriate one-time password that should have been generated (or calculated) by the token. Once verified, and if correct, the service provider 320 establishes a session and notifies 648 the user accordingly. If the one-time password is incorrect, the service provider may ask the user to try again or block the user altogether.

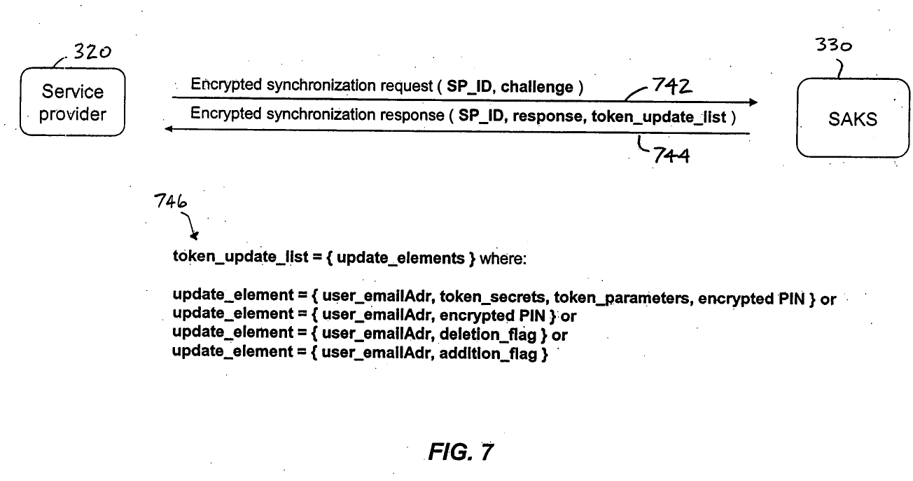

In order for the service provider 320 to authenticate without the secured authentication and key system 330 intervening, the service provider 320 should be synchronized with the secured authentication and key system 330. FIG. 7 illustrates one embodiment of a process for single PIN synchronization in accordance with the present invention. As previously noted, the service provider 320 requests 742 synchronization with the secured authentication and key system 330 and sends an encrypted version of its service provider 320 identification and a cryptographic challenge code to the secured authentication and key system 330. In response, the secured authentication and key system 330 transmits 744 back an encrypted version of an updated token transaction list 746 together with a cryptographic response code to the service provider 320. The cryptographic challenge-response mechanism is one common means for mutual authentication. Upon successful mutual authentication using the cryptographic challenge-response mechanism, the service provider 320 updates its database with this synchronized information.

The updated token transaction list 746 contains one or more token update elements. Examples of token update elements that may be synchronized includes user email addresses, token secrets, token parameters (including encrypted PIN). Alternatively, a token update element may contain just user email address and encrypted PIN, for example, when only PIN information has changed. In addition, the token update element may contain user email address and a deletion flag when the user has indicated a desire to delete the service provider 320. Likewise, it may contain user email address and an addition flag when the user has indicated a desired to add the service provider 320.

Upon successful token synchronization with the secured authentication and key system 330, the service provider 320 has maintained the updated token datasets for all its users 310. Verification of one-time passwords is usually done through a predefined algorithm consisting of programmed computational steps and cryptographic operations. For example, the service provider 320 (using its authentication server 226) would derive a prediction index to the monotonically increasing sequence number from the given one-time password of the user 310. Based on the predicted sequence number, the authentication server 226 can feed the corresponding token secrets and parameters (including the encrypted PIN) into a pre-defined one-time password cryptographic algorithm to compute a one-time password. Verification is successful if the computed one-time password and the given one-time password match.

The disclosed systems and methods include a number of advantages and benefits over existing one-time password technology. For example, there is an advantage of eliminating a need for different passwords for different systems through enabling use of a single one-time password token and a single PIN for different systems. In addition, a user token application may be partitioned such that the token dataset can be compartmentalized for different service providers so that a central authority would handle token management and synchronize with authentication servers of different service providers, while still allowing service providers to directly authenticate their own users.

Another advantage is how the disclosed systems and methods differ from conventional token solutions in providing an open system for a user to use the same token and PIN for all service providers. This benefit allows a user to download a token application once and thereafter automatically enable it for use with different service providers. Unlike conventional PKI system, the system and process disclosed does not use client side digital certificates. Rather, the user's PIN beneficially is encrypted for each service provider and independently validated by each service provider. Each individual service provider can download the encrypted PIN and token secrets and parameters from a central authority (e.g., the secured authentication and key system) using a secure computer-to-computer channel such that individual service provider can directly authenticate their own users.

Thus, the disclosed systems and methods are beneficially user friendly and secure. For example, with respect to user friendliness, each user needs to recall only one one-time password token. Thus, the user can use just one PIN for all applications and web sites that the user visits. This removes the inconvenience to remember many passwords for different systems. Similarly, with respect to security, there is beneficial application of two-factor authentication. The first factor is “what you know” and that is the user's PIN. The second factor is “what you have” and that is the user's token. The user's token beneficially can be device separate from the primary device used to access an application or web site such as the user's personal computer, smartphone, mobile phone, a dedicated token device, or a portable device.

In addition to the advantages and benefits described herein, segregating user authentication from one-time password token management, allows for implementing a system and a method as a common infrastructure over established networks, for example, the Internet and other online networks. Hence, this configuration allow for a user to only need a single one-time password token and a single PIN for all visited applications and web sites.

Further, the features and advantages described in the specification provide a beneficial use to those making use of a system and a method as described in embodiments herein. For example, a user is provided mechanisms, e.g., by receiving and/or transmitting control signals, to control access to particular information as described herein. Further, these benefits accrue regardless of whether all or portions of components, e.g., server systems, to support their functionality are located locally or remotely relative to the user.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using one or more hardware elements. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Various embodiments may be implemented using one or more software elements. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations. The software may be written or coded using a programming language. Examples of programming languages may include C, C++, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. Examples of software may include any software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using any computer-readable media, machine-readable media, or article capable of storing software. The media or article may include any suitable type of memory unit, memory device, memory article, memory medium, storage device, storage article, storage medium and/or storage unit, such as any of the examples described with reference to a memory. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of embodiments of the present invention. This was done merely for convenience and to give a general sense of the embodiments of the present invention. This description should be read to include one or at least one and the singular also includes the plural unless it is obvious that it is meant otherwise.

Upon reading this disclosure, those of skill in the art will appreciate still additional alternative structural and functional designs for a system and a method that allows a user to use a single token and a single PIN to access a multitude of service providers having a relationship with the user, that allows a centralized token management for issuance, revocation and re-issuance by an authority, and also allows participating service providers to directly authenticate the user identity, all through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A mechanism to generate a one-time password using a single personal identification number, the mechanism comprising:
an input configured to receive the personal identification number;
a token application including a token dataset, the token dataset including a plurality of compartments, each compartment corresponding to a reciprocal transaction party, the compartment including a token secret and a token parameter, the token application configured to generate a one-time password in response to the received personal identification number, the one time password generated from the token dataset and the token parameter of the compartment corresponding to the reciprocal transaction party;
an output configured to transmit a unique identifier and the one time password to the reciprocal transaction party.

2. The mechanism of claim 1, wherein the token secret comprises at least one of a cryptographic key, random number, a control vector or combinations thereof.

3. The mechanism of claim 2, wherein the token parameter comprises at least one of an encrypted personal identification number and a monotonically increasing or decreasing sequence number.

4. The mechanism of claim 1, further comprising at least one cryptographic module for at least one of encrypting signals to transmit through the output and decrypting signals received through the input.

5. A method to issue a token for secured transactions, the method comprising:
generating, in response to a request for a token, a token dataset, the token dataset including a token secret and a token parameter;
transmitting a token application to a first party, the token application including a cryptographic algorithm and the token dataset;
receiving a request for authentication from a first party, the request including a unique identifier and a physical device identifier;
transmitting a request containing an authorization code to the first party;
receiving the authorization code from the first party;
transmitting a one-time password token dataset and application to a physical device corresponding to the physical device identifier of the first party; and
transmitting synchronization information of the one-time password token dataset and application to a second party.

6. The method of claim 5, wherein the unique identifier is an electronic mail address.

7. The method of claim 5, wherein the physical device identifier comprises a mobile telephone identifier.

8. The method of claim 5, wherein the physical device identifier comprises a media access control identifier.

9. The method of claim 5, further comprising receiving a hash of a personal identification number (PIN), the PIN set in response to the one-time password token application.

10. The method of claim 5, further comprising receiving from the second party a request for synchronization information.

11. The method of claim 10, wherein the synchronization information comprises an identifier for the second party and a token update list, the token update list includes the one-time password token dataset or its subset.

12. The method of claim 11, wherein the synchronization information further comprises the unique user identifier, a token dataset including token secrets and a hashed and/or encrypted personal identification number (PIN) received from the first party.

13. A system including a first party, at least one second party, and a third party, the system comprising:
a token generator configured to generate a token dataset in response to a request for a token, the token dataset including a token secret and a token parameter;
a transmission interface to transmit a token application to a first party, the token application including a cryptographic algorithm and the token dataset;
a master authentication server of the third party configured to either issue or update a one-time password token dataset and application for the first party and to notify the second party of the token secrets and parameters corresponding to the one-time password token of the first party; and
a service provider authentication server of the second party configured to verify the one-time password submitted by the first party to the second party.

14. The system of claim 13, wherein the one-time password token dataset in the token of the first party is logically partitioned for each second party.

15. The system of claim 13, wherein the one-time password token application of the first party operates with the same personal identification number (PIN) for each second party interacting with the first party.

16. The system of claim 13, wherein the second party verifies one-time passwords generated from the tokens of a plurality of first parties.

17. The system of claim 14, wherein the third party issues or updates one-time password token datasets and applications of a plurality of first parties.

18. The system of claim 17, wherein the third party synchronizes the one-time password token datasets and applications of the plurality of first parties with a plurality of second parties.

19. A computer readable medium adapted to store instructions executable by a processor, the instructions for issuance of a token dataset and application for secured transactions that when executed by the processor cause the processor to:
generate, in response to a request for a token, a token dataset, the token dataset including a token secret and a token parameter;
transmit a token application to a first party, the token application including a cryptographic algorithm and the token dataset;
receive a request for authentication from a first party, the request including a unique identifier and a physical device identifier;
transmit a request containing an authorization code to the first party;
receive the authorization code from the first party;
transmit a one-time password token dataset and application to a physical device corresponding to the physical device identifier of the first party; and
transmit synchronization information of the one-time password token dataset and application to a second party.

20. The computer readable medium of claim 19, wherein the unique identifier is one of an electronic mail address and a mobile telephone identifier.

21. The computer readable medium of claim 19, further comprising instructions that cause the processor to receive a hash of a personal identification number (PIN), the PIN set in response to the one-time password token application.

22. The computer readable medium of claim 19, further comprising instructions to cause the processor to receive from the second party a request for synchronization information.

23. The computer readable medium of claim 22, wherein the synchronization information comprises an identifier for the second party and a token update list, the token update list includes the one-time password token dataset or its subset.
